(19) United States
(12) Patent Application Publication
(10) Pub. No.: US 2020/0232707 A1
(43) Pub. Date: Jul. 23, 2020

(54) Method And Apparatus For Controlling The Nitriding Potential Of A Nitriding, Nitro-Carburizing Or Carbonitriding Atmosphere

(71) Applicant: Air Products and Chemicals, Inc., Allentown, PA (US)

(72) Inventors: Liang He, Allentown, PA (US); Guido Plicht, Dortmund (DE); Ranajit Ghosh, Macungie, PA (US); Donald James Bowe, Zionsville, PA (US)

(73) Assignee: Air Products and Chemicals, Inc., Allentown, PA (US)

(21) Appl. No.: 16/250,294

(22) Filed: Jan. 17, 2019

(51) Int. Cl. F27D 19/00; C23C 8/24

(52) U.S. Cl. CPC F27D 19/00; F27D 2019/0068; F27D 2019/0015; C23C 8/24

(57) ABSTRACT

A method and an apparatus for nitriding metal articles, wherein the nitriding potential of the nitriding atmosphere is controlled as a function of the molecular weights of the inlet and outlet gases from the nitriding apparatus, as measured by molecular weight sensors located outside (external to) the furnace chamber.

### BACKGROUND

Nitriding is a heat-treating process that diffuses nitrogen into the surface of a metal to create a hardened surface. In gas nitriding the donor is a nitrogen rich gas, usually ammonia (NH3), which is sometimes known as ammonia nitriding. Gas nitriding processes use nitrogen and ammonia as the atmosphere in a hot chamber/furnace to transfer nitrogen atoms into the heated work pieces for surface hardening. In the hot chamber/furnace, ammonia partially dissociates into nitrogen and hydrogen when it gets heated and comes into contact with the heated work pieces or other catalytic material. The nitrogen then diffuses onto the surface of the material creating a nitride layer. This process has existed for decades, though only in the last few decades has there been a concentrated effort to investigate the thermodynamics and kinetics involved.

The nitriding process is not an equilibrium process since the dissociation rate is, apart from the temperature, a function of several parameters including atmosphere turnover rate and catalytic surface area. It is desirable that not all of the ammonia should be dissociated into N₂ and H₂, because only the reaction of the undissociated NH₃ molecule itself on the surface of the metal article into atomic N and H₂ can provide nitrogen for nitriding process. The dissociation rate of ammonia is the ratio of the dissociated ammonia to the total injected ammonia and has an impact on the nitriding potential Kₙ, which usually is adopted as the atmosphere controlling parameter. Kₙ is defined in relation to the partial pressures of NH₃ and H₂ according to the equation: K_{N}=pNH₃/p^{1.5}H₂.

Gas nitriding process parameters include temperature, time, and the composition of the nitriding atmosphere. For nitriding atmosphere control, the ammonia dissociation rate was traditionally adopted as the controlling parameter. It represents the percentage of ammonia dissociated into hydrogen and nitrogen. To measure the dissociation rate of ammonia, several different methods are used.

An in-situ gas sensor, also referred to as an analyzer, can be used to measure the hydrogen or ammonia concentrations inside the chamber of the furnace. A preferred sensor for hydrogen is a thermal conductivity type sensor. A preferred sensor for ammonia is an infrared absorption type sensor. If the sensors measure the hydrogen and ammonia concentrations at the same time, the dissociation rate of ammonia can be calculated in real time. If there is only a hydrogen sensor, the operator can obtain the inlet flow rates of nitrogen and ammonia by using flow meters on the gas feed system and use those values to calculate a dissociation rate.

Other in-situ sensors, for example an oxygen probe, can also be installed for calculating the nitriding potential. But, they depend on using empirical factors or equations. For this application, the oxygen probe is not used as an oxygen analyzer, but as a measurement tool to provide the status of all the reactions happening in the furnace. The reading of oxygen probe must be linked to the reaction of dissociation of ammonia. As mentioned above, the nitriding atmosphere is not in an equilibrium state, so the relationship between the reading of the oxygen probe and the ammonia dissociation reaction depends on the kinetics of the reaction, which cannot be measured directly and has to be treated using empirical factors and running empirical calculations. A further disadvantage of this method is that any temperature or furnace condition changes may affect the accuracy of calculations.

Another method is using a burette to measure the amount of ammonia in the exhaust gas. Ammonia is the only constituent of the nitriding process that is soluble in water and is therefore amenable to this procedure. A graduated burette filled with water is used to measure the ammonia dissociation rate of the furnace exhaust gas.

In other methods it is possible to install gas analyzers, for example, laser-based sensors, to measure the composition of the exhaust gas and calculate the dissociation rate of ammonia using known inlet gas flow rates. In some applications, measurements are not used at all and nitriding operators merely run a simulation with empirical factors/equations to set the nitriding parameters. In all the methods using gas analyzers, the focus is to determine the composition of the atmosphere in the furnace.

Each of the prior art methods for controlling the nitriding atmosphere during the nitriding process has inherent disadvantages. In the in-situ gas sensor/analyzer methods, the sensor/analyzer meets the hot gas. Also, at high temperature, ammonia attacks the sensor/analyzer more strongly. The system must be well designed to ensure a long service life. The installation is complicated, and the maintenance is expensive. The method of using a burette to measure ammonia in the exhaust gas is a manual method. Therefore, it cannot be continuously performed and involves operator-induced variability. The methods that rely on measuring only the composition of exhaust gas provide the after-process atmosphere composition. The inlet nitrogen and ammonia flow must be provided by feed gas flow meters. This group of methods is limited by the accuracy of flow meters used for inlet nitrogen and ammonia flow.

Although a variety of methods to measure a nitriding atmosphere are known, these methods yield a large variation in nitriding depth in the article or work piece being treated. There is an unmet need for a method of controlling the nitriding atmosphere during a nitriding process that provides improved control of the nitriding potential of the nitriding atmosphere, thereby providing greater control of the nitriding depth in the article being nitrided and overcoming the other limitations of the known methods described above.

### SUMMARY OF INVENTION

In embodiments of this invention, at least two gas molecular weight sensors are installed on the nitriding apparatus. One gas molecular weight sensor is installed in the atmosphere feed conduit, also referred to herein as the inlet, to measure the molecular weight of the feed gas before it enters the furnace. A preferred feed gas is a mixture of nitrogen and ammonia. The other gas molecular weight sensor is installed in the exhaust, or outlet, conduit, or in a furnace atmosphere sampling conduit, to measure the molecular weight of the mixture of nitrogen, ammonia and hydrogen in the nitriding atmosphere. By running calculations with the outputs of the two gas molecular weight sensors, the dissociation rate of ammonia can be determined and used to control the nitriding atmosphere by adjusting the flowrate of nitrogen and/or ammonia being fed to the furnace.

In embodiments of this invention, the gas molecular weight sensors are located in gas conduits outside the furnace, not within the furnace. This ensures easy installation and maintenance. Since the sensors are external to the furnace, they are not exposed to high temperatures. This provides a longer service life and less maintenance. It also eliminates the effects of the temperature variation to ensure a more accurate measurement. In this invention, all the measurements are continuous and automatic. It ensures a better atmosphere control for the nitriding process.

In addition, several specific aspects of the systems and methods of the present invention are outlined below.

Aspect 1: A method of controlling a nitriding potential of a furnace having a chamber, at least one inlet conduit in fluid flow communication with the chamber, and at least one outlet conduit in fluid flow communication with the chamber, the method comprising:
(a) performing a nitriding process on a work piece located in the chamber, the nitriding process comprising:
   i. heating the chamber to a temperature equal to or greater than 350 degrees;
   ii. supplying an inlet gas feed comprising an ammonia feed and a premix feed to the chamber through the at least one inlet conduit; and iii. exhausting an outlet gas feed through the at least one outlet conduit;
(b) measuring a molecular weight of one selected from the group of a premix feed and the inlet gas feed using the at least one inlet gas molecular weight sensor located on one of the at least one inlet conduit and located external to the chamber;
(c) measuring a molecular weight of the outlet gas feed using at least one outlet gas molecular weight sensor located on one of the at least one outlet conduit and located external to the chamber;
(d) controlling at least one operating parameter of the process as a function of the molecular weight of the inlet gas feed measured in step (b) and the molecular weight of the outlet gas feed measured in step (c); and
(e) performing steps (b) through (d) during at least a portion of the performance of step (a).

Aspect 2: The method of Aspect 1, wherein step (e) further comprises repeatedly performing steps (b) through (d) during at least a portion of the performance of step (a).

Aspect 3: The method of any of Aspects 1-2, wherein step (b) further comprises measuring a molecular weight of the inlet gas feed using the at least one inlet gas molecular weight sensor located on one of the at least one inlet conduit and located external to the chamber.

Aspect 4: The method of any of Aspects 1-3, wherein step (d) comprises controlling at least one operating parameter of the process as a function of the measured inlet and outlet gas molecular weights, wherein the operating parameter is selected from the group consisting of an ammonia flow rate to the at least one inlet conduit, a nitrogen flowrate to the at least one inlet conduit, and the temperature of the chamber.

Aspect 5: The method of any of Aspects 1-4, wherein step (a)(ii) further comprises mixing the premix feed and the ammonia feed upstream from the inlet gas molecular weight sensor.

Aspect 6: The method of Aspect 5, wherein step (a)(ii) further comprises supplying the inlet gas feed comprising the ammonia feed and the premix feed to the chamber through the at least one inlet conduit, the premix feed consisting of nitrogen.

Aspect 7: The method of Aspect 5, wherein step (a)(ii) further comprises supplying a nitrogen gas feed, a hydrogen gas feed, and the ammonia gas feed, mixing the hydrogen gas feed with the nitrogen gas feed to create the premix gas feed and wherein step (b) further comprises measuring a molecular weight of the premix gas feed using the at least one inlet gas molecular weight sensor.

Aspect 8: The method of any of Aspects 1-7, wherein the at least one outlet conduit includes a primary outlet conduit and a sampling conduit having sampling pump and step (c) further comprises:
i. activating the sample pump to cause a gas sample to be withdrawn from the chamber and into the sampling conduit; and
ii. measuring the molecular weight of the outlet gas feed using the at least one sampling conduit gas molecular weight sensor located in the sampling conduit.

Aspect 9: An apparatus for nitriding a metal article comprising:

a furnace having a chamber;

a premix conduit in fluid flow communication with a supply of nitrogen gas; an ammonia conduit in fluid flow communication with a supply of ammonia;

an inlet feed conduit in fluid communication with, and downstream from, the premix conduit and the ammonia conduit;

an inlet molecular weight sensor located external to the chamber and on one selected from the group of the premix conduit and the inlet feed conduit;

at least one exhaust conduit in fluid flow communication with the chamber;

an exhaust molecular weight sensor located external to the chamber and on one of the at least one exhaust conduit;

a controller in electrical communication with the inlet molecular weight sensor and the exhaust molecular weight sensor, the controlled being operationally configured to collect molecular weight data based on electrical signals received from the inlet molecular weight sensor and the exhaust molecular weight sensor;

wherein the controller is operationally configured to control at least one operational parameter of the apparatus as a function of the collected molecular weight data, the at least one operation parameter including a flow rate of ammonia through the ammonia conduit.

Aspect 10: The apparatus of Aspect 9 wherein the at least one operational parameter comprises at least one selected from the group consisting of the flow rate of ammonia through the ammonia conduit, a flow rate of nitrogen through the nitrogen premix conduit, and a temperature of the chamber.

Aspect 11: The apparatus of any of Aspects 9-10, wherein the inlet molecular weight sensor is located on the inlet feed conduit.

Aspect 12: The apparatus of any of Aspects 9-11, wherein the controller is operationally configured to calculate a nitriding potential of the chamber as a function of the molecular weight data.

Aspect 13: The apparatus of any of Aspects 9-12, wherein the at least one exhaust conduit in fluid flow communication with the chamber comprises a primary exhaust conduit and a sample conduit, the sample conduit including a sampling pump that is operationally configured to selectively enable fluid flow through the sample conduit, wherein the exhaust molecular weight sensor is located on the sampling conduit.

Aspect 14: The apparatus of any of Aspects 9-13, wherein the premix conduit is in fluid flow communication with a supply of nitrogen gas and a supply of hydrogen gas.

Aspect 15: The apparatus of Aspect 14, wherein the inlet molecular weight sensor is located on the premix conduit.

Aspect 16: The method of any of Aspects 1-8, wherein step (d) further comprises calculating an ammonia dissociation rate as a function of the molecular weight of the inlet gas feed measured in step (b) and the molecular weight of the outlet gas feed measured in step (c).

Aspect 17: The method of Aspect 16, wherein step (d) further comprises calculating a nitriding potential of the furnace.

Aspect 18: The method of Aspect 16, wherein the controller is operationally configured to perform a diffusion model to predict the final nitride layer thickness that will be generated on the work piece.

Aspect 19: The apparatus of any of Aspects 9-15, wherein the at least one of the inlet molecular weight sensor and the exhaust molecular weight sensor is operationally configured to measure at least one of a gas pressure, a gas temperature and a gas density.

### BRIEF DESCRIPTION OF THE DRAWINGS

The present invention will hereinafter be described in conjunction with the appended drawing figures wherein like numerals denote like elements.

FIG. 1 is a block diagram of a first exemplary embodiment of a nitriding system;

FIG. 2 is a block diagram of a second exemplary embodiment of a nitriding system;

FIG. 3 is a block diagram of a third exemplary embodiment of a nitriding system; and

FIG. 4 is a block diagram of a fourth exemplary embodiment of a nitriding system.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It should be understood that various changes may be made in the function and arrangement of elements without departing from the spirit and scope of the invention, as set forth in the appended claims.

Directional terms may be used in the specification and claims to describe portions of the present invention (e.g., upper, lower, left, right, etc.). These directional terms are merely intended to assist in describing exemplary embodiments and are not intended to limit the scope of the claimed invention. As used herein, the term “upstream” is intended to mean in a direction that is opposite the direction of flow of a fluid in a conduit from a point of reference. Similarly, the term “downstream” is intended to mean in a direction that is the same as the direction of flow of a fluid in a conduit from a point of reference.

In this disclosure, elements shared between embodiments are represented by reference numerals increased by factors of 100. In the interest of clarity, some features of the embodiments that are shared with an earlier embodiment are numbered in subsequent figures but are not repeated in the specification. If a numbered feature is not specifically described in a subsequent embodiment, it may be assumed that this feature is substantially identical in structure and performs substantially the same function as in the last embodiment in which the feature was described.

The term “fluid flow communication,” as used in the specification and claims, refers to the nature of connectivity between two or more components that enables liquids, vapors, and/or gases to be transported between the components in a contained fashion (i.e., without substantial leakage). Coupling two or more components such that they are in flow communication with each other can involve any suitable method known in the art, such as with the use of welds, flanged conduits, gaskets, and bolts. Two or more components may also be coupled together via other components of the system that may separate them.

The terms “nitriding” or “nitriding process”, as used in the specification and claims, refer to any nitriding process, or stand-alone nitriding step in a nitrocarburizing process, or stand-alone nitriding step in carbonitriding process.

The term “conduit,” as used in the specification and claims, refers to one or more structures through which fluids can be transported between two or more components of a system. For example, conduits can include but are not limited to pipes, ducts, passageways, and combinations thereof that transport liquids, vapors, and/or gases.

Embodiments of the present invention provide a method and apparatus for controlling the nitriding potential of the atmosphere inside the chamber of a nitriding furnace. The nitriding potential of the atmosphere inside the chamber is a critical factor for controlling the depth and characteristics of the nitride layer that diffuses into the article being nitrided. As used herein, the term nitriding refers to a diffusion process whereby a metallic article's surface is enriched with nitrogen and results in increased surface hardness, wear resistance and corrosion resistance. The methods and systems disclosed herein apply equally to other diffusion processes, including but not limited to, carburizing, nitrocarburizing and carbonitriding.

The method uses the measurements obtained through at least two gas molecular weight sensors. A central controller is in electrical communication with the sensors and with flow control units for the inlet nitriding gases, for example, nitrogen and ammonia. The controller contains executable code that provides for the adjustment of the flow control units as a function of the measurements obtained by the gas molecular weight sensors to maintain the nitriding potential of the nitriding atmosphere at a desired level.

Suitable gas molecular weight sensors for use in embodiments of this invention will also have components for measuring the gas temperature, gas pressure and gas density. Suitable gas molecular weight sensors and their method of use are described in US Patent Application Publication No. 20140000342A1, the disclosure of which is incorporated herein by reference in its entirety.

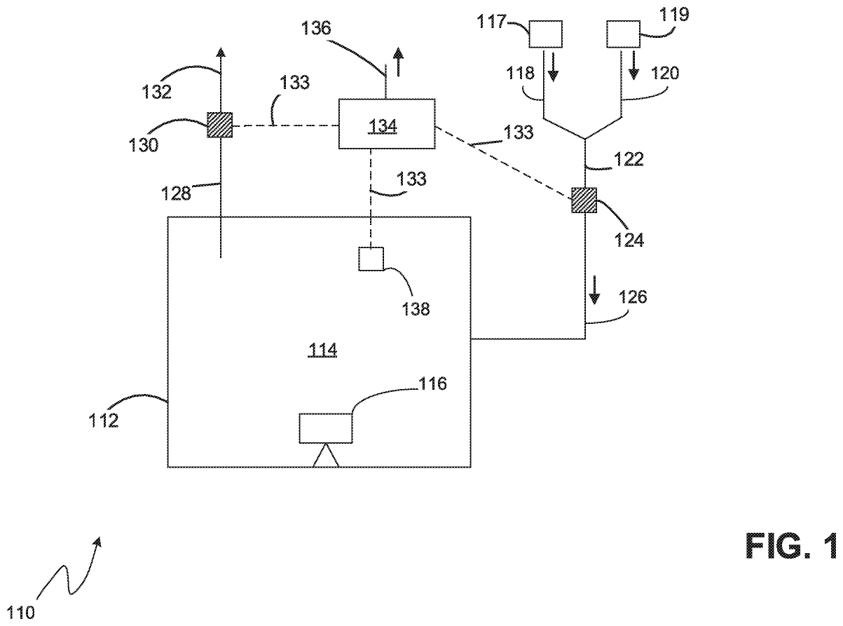

Referring to FIG. 1, an embodiment of a nitriding system 110 according to the claimed invention is shown. The nitriding system 110 comprises a furnace 112 enclosing a nitriding chamber 114 (also referred to as an atmosphere or nitriding atmosphere). An article 116 (also referred to as a work piece) to be nitrided is placed inside the chamber 114 and is in contact with the nitriding atmosphere. Sources of nitriding feed gases, for example nitrogen 117 and ammonia 119 are provided and supply feed gas via feed conduits 118, 120. In most embodiments the feed gasses are mixed into a single feed conduit 122 prior to entering the furnace 112.

An inlet gas molecular weight sensor 124 is installed in the nitriding furnace feed conduit, preferably after the mix point of nitrogen and ammonia. It measures the molecular weight of the mixture of nitrogen and ammonia as it is being fed into the furnace via the inlet conduit 126. A second gas molecular weight sensor 130 is installed in the exhaust conduit 128 of the nitriding furnace 112 prior to the exhaust being vented 132 to the atmosphere.

In the chamber 114, part of the ammonia dissociates into nitrogen and hydrogen gas when the ammonia touches hot surfaces. The reaction is described by Reaction 1, below. The temperature inside the chamber is preferably above 350 degrees Celsius, more preferably the temperature is above 500 degrees Celsius.

NH₃=N+ 3/2H₂ Reaction 1

The nitriding potential of the nitriding atmosphere, Kₙ, is a relationship between the partial pressure of ammonia still present in the furnace (the ammonia that has not yet dissociated) and the partial pressure of hydrogen in the atmosphere (the hydrogen that has already dissociated from ammonia). The relationship is given by Equation 1, below.

Kₙ=pNH₃/p^{1.5}H₂ Equation 1.

In Equation 1, Kₙ is nitriding potential of the nitriding atmosphere, pNH₃ is partial pressure of ammonia, and pH2 is the partial pressure of hydrogen.

A controller 134 in electrical communication 133 with the molecular weight sensors 124, 130 and a furnace temperature monitor 138, is programmed to calculate Kn. The controller 134 is preferably programmed to perform a diffusion model to predict the final nitride layer thickness and composition that will be generated on the article 116 by the nitriding atmosphere 114, using the calculated Kₙ value. The controller 134 can then compare the model result with a target thickness to determine how to adjust the flow of nitrogen and ammonia to modify the Kₙ value to align the model result with the target result.

The molecular weight measurements of the inlet and outlet gases are used by the controller 134 in calculations that enable control over the nitriding potential. As mentioned above, a portion of the ammonia in the feed gas dissociates, following Reaction 1. The dissociation rate of ammonia is defined as the percentage of dissociated ammonia in the total ammonia that is introduced into the furnace. Reaction 1 can be re-written in the format of Reaction 2, representing the partial dissociation of ammonia.

$$1 {NH}_{3} = ( 1 - X ) {NH}_{3} + ( X \text{/} 2 ) {N}_{2} + ( \frac{3 X}{2} ) {H}_{2} . \qquad Reaction 2$$

In Reaction 2, X is the number of moles of ammonia that have dissociated.

At any time during the nitriding process, A mol. of N₂ and B mol. of NH₃ have been introduced into the chamber 114. Accordingly, Reaction 2 can be re-written in the format of Reaction 3, below.

$$( A ) N 2 + ( B ) NH 3 = ( A ) N 2 + ( B \times ( 1 - X ) ) NH 3 + ( B \times ( \frac{X}{2} ) ) N 2 + ( B \times ( \frac{3 X}{2} ) ) H 2. \qquad Reaction 3$$

In Reaction 3, A is the number of moles of nitrogen, B is the number of moles of ammonia, and X is the number of moles of ammonia that have dissociated.

In the furnace atmosphere (chamber 114), the partial pressure of NH₃ is B*(1−X)/(A+B*(1−X)+B*(X/2)+B*(3X/2)) =B*(1−X)/(A+B*(1+X)); and the partial pressure of H₂ is B*(3X/2)/(A+B*(1−X)+B*(X/2)+B*(3X/2)) =B*(3X/2)/(A+B*(1+X)). The nitriding potential of the atmosphere can be written as Equation 2, below.

$${K}_{n} = \frac{( B \times ( 1 - X ) ) \text{/} ( A + B \times ( 1 + X ) )}{{( ( B \times \frac{3 X}{2} ) \text{/} ( A + B \times ( 1 + X ) ) )}^{1.5}} . \qquad Equation 2$$

In Equation 2, A is the number of moles of nitrogen, B is the number of moles of ammonia, and X is the number of moles of ammonia that have dissociated. Kₙ is the nitriding potential of the nitriding atmosphere.

In this embodiment, the controller 134 reads the output of the gas molecular weight sensors 124, 130. The controller then uses the measurements to calculate the dissociation rate of ammonia and the nitriding potential, Kₙ.

Referring to the embodiment illustrated in FIG. 1, when using a mixture of nitrogen 117 and ammonia 119 to form the nitriding atmosphere 114, the molecular weight reading (MW_1) from the inlet gas molecular weight sensor can be described as Equation.3.

MW_1=(MW_{N}_{₂}×A_{N}_{₂}+MW_{NH}_{₃}×A_{NH}_{₃})/(A_{N}_{₂}+A_{NH}_{₃}) Equation 3.

In Equation 3, A_{N2} and A_{NH3} are the percentages of nitrogen and ammonia, respectively, in the gas mixture. The molecular weights of nitrogen and ammonia, MW_{N2} and MW_{NH3}, respectively, are known. The inlet gas molecular weight sensor measures MW_1. Since the inlet feed gas is comprised entirely of nitrogen and ammonia, Equation 4 must be true.

A_{N2}+A_{NH3}=1 Equation 4.

In Equation 4, A_{N2} and A_{NH3} are the percentages of nitrogen and ammonia, respectively, in the gas mixture.

Combining Equations 3 and 4, the values of A_{N2} and A_{NH3} can be calculated. Using the method of this invention allows the composition of the inlet gas to be directly measured by the molecular weight sensors, rather than relying on gas flow meters as practiced in the prior art. Direct measurement of molecular weight improves the reliability and accuracy of the process control by eliminating any error or drift that might exist with flow meters.

Referring again to the system illustrated in FIG. 1, the outlet gas molecular weight sensor 130 measures the molecular weight of the mixture of nitrogen, ammonia and hydrogen exiting from the furnace 112 via the exhaust conduit 128. As described in Reactions 1 and 2, ammonia dissociates partially into nitrogen and hydrogen inside the heated furnace. The molecular weight reading (MW_2) from the outlet gas molecular weight sensor 130 relates to the composition of the outlet gas described as Equation 5, below.

$$MW\_ 2 = \begin{matrix}( \begin{matrix}M {W}_{{N}_{2}} \times {A}_{{N}_{2}} + M {W}_{{N}_{2}} \times ( {A}_{{NH}_{3}} \times \frac{D}{2} ) + M {W}_{{NH}_{3}} \times \\ {A}_{{NH}_{3}} \times ( 1 - D ) + M {W}_{{H}_{2}} \times 3 \text{/} 2 \times {A}_{{NH}_{3}} \times D\end{matrix} ) \text{/} \\ ( {A}_{{N}_{2}} + {A}_{{NH}_{3}} \times \frac{D}{2} + {A}_{{NH}_{3}} \times ( 1 - D ) + 3 \text{/} 2 \times {A}_{{NH}_{3}} \times D ) .\end{matrix} \qquad Equation 5$$

In Equation 5, A_{N2} and A_{NH3} are the percentages of nitrogen and ammonia, respectively, in the gas mixture. The values of A_{N2} and A_{NH3} are calculated based on the molecular weight measurement at the inlet sensor 124 using Equation 3. The molecular weights of nitrogen MW_{N}_{₂}, ammonia (MW_{NH}_{₃}), and hydrogen MW_{H}_{₂}, are known. Using the measured value of MW_2, the dissociation rate of ammonia (D) in Equation 5 can be calculated. With the dissociation rate of ammonia (D) known, the nitriding potential Kₙ can be calculated using Equation 2.

The controller compares the calculated nitriding potential with a desired predetermined value. The controller is configured to adjust the composition of the inlet gas using flow rate controllers (not shown) on the inlet gas feed conduits to effect a change in composition.

The equations and method for calculating Kₙ described above also apply in the situation in which only ammonia is used as inlet gas for the nitriding process. In such an embodiment, A_{N2} has a value of zero percent and A_{NH3} has a value of 100 percent.

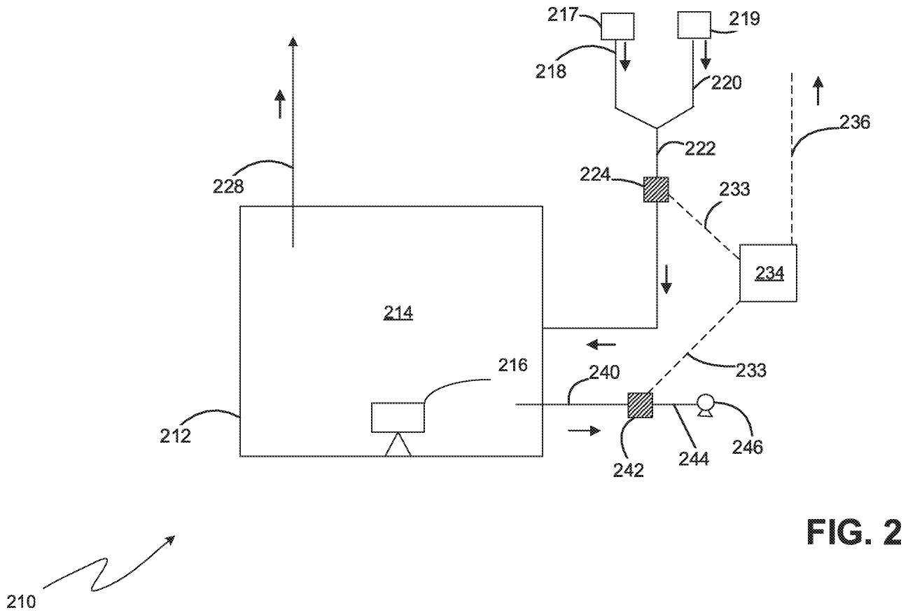

FIG. 2 illustrates an embodiment of a nitriding system 210 where there is no sensor in the exhaust conduit 228 from the furnace 212. In this embodiment, a sample conduit 240 is in fluid flow communication with the nitriding atmosphere 214 and a sampling pump 246. The sampling pump is configured to withdraw a sample of the nitriding atmosphere 214 through the sampling conduit 240, 242 where the molecular weight of the gas is measured by the sampling conduit gas molecular weight sensor 242. The method and calculations proceed as described in the embodiment illustrated in FIG. 1, but with the measurement of MW_2 occurring at the sampling conduit gas molecular weight sensor 242 rather than the outlet gas molecular weight sensor 130.

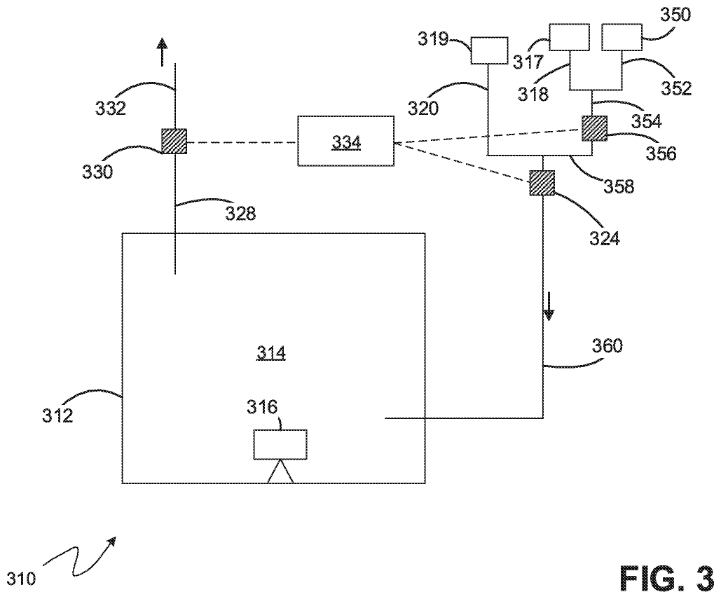

FIG. 3 illustrates an embodiment where a source of hydrogen or dissociated ammonia (N2—H2) 350 is added into the inlet gas mixture of nitrogen 317 and ammonia 319, to adjust the nitriding potential of the furnace atmosphere. The additional source gas requires an additional gas molecular weight sensor to determine the composition of inlet gas mixture. By knowing the composition of the inlet gas mixture and measuring the molecular weight of the furnace atmosphere or exhaust gas mixture, the dissociation rate of ammonia and the nitriding potential of furnace atmosphere can be calculated using an analogous method and equations to those described in the embodiment illustrated in FIG. 1.

Referring to FIG. 3, a nitriding system 310 is shown having a feed conduit 318 from a nitrogen source 317 joining with a feed conduit 352 from a hydrogen source 350 to form a combined premix feed 354. The molecular weight of the premix feed is measured by the premix gas molecular weight sensor 356. The premix feed 358 is then combined with a feed 320 from the ammonia source 319 to create the inlet gas 360. The molecular weight of the combined inlet gas 360 is measured using the inlet gas molecular weight sensor 324 before it is fed into the nitriding atmosphere 314 inside the furnace 312.

In this embodiment, the controller 334 is in electrical communication with all three sensors 324, 330, 256. The controller collects measurements from the gas molecular weight sensors and performs calculations analogous to those described for the embodiment of FIG. 1. The controller is configured to adjust the flowrate of all three feed gases to adjust the nitriding potential of the nitriding atmosphere as necessary.

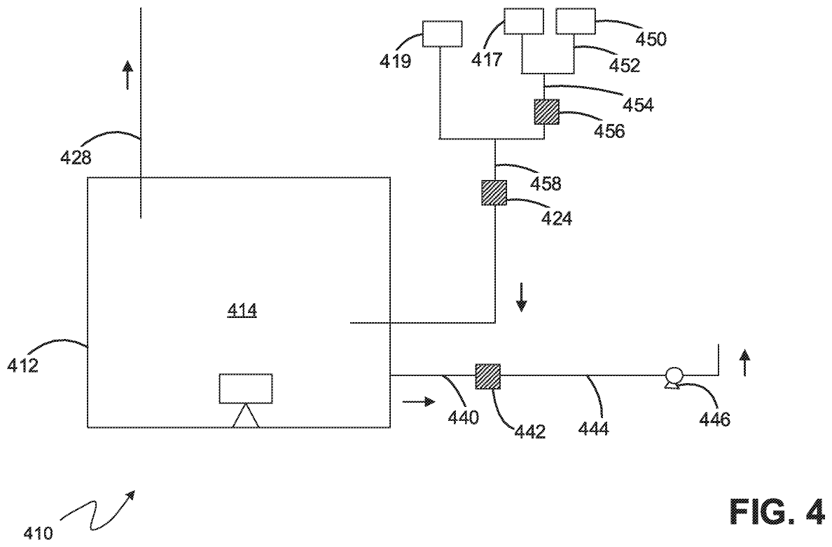

FIG. 4 illustrates an embodiment of a nitriding system 410 that combines the sampling conduit component discussed with respect to FIG. 2 and a pre-mix inlet gas system discussed in reference to FIG. 3.

While the principles of the invention have been described above in connection with preferred embodiments, it is to be clearly understood that this description is made only by way of example and not as a limitation of the scope of the invention.

1. A method of controlling a nitriding potential of a furnace having a chamber, at least one inlet conduit in fluid flow communication with the chamber, and at least one outlet conduit in fluid flow communication with the chamber, the method comprising:
(a) performing a nitriding process on a work piece located in the chamber, the nitriding process comprising:
i. heating the chamber to a temperature equal to or greater than 350 degrees;
ii. supplying an inlet gas feed comprising an ammonia feed and a premix feed to the chamber through the at least one inlet conduit; and
iii. exhausting an outlet gas feed through the at least one outlet conduit;
(b) measuring a molecular weight of one selected from the group of a premix feed and the inlet gas feed using the at least one inlet gas molecular weight sensor located on one of the at least one inlet conduit and located external to the chamber;
(c) measuring a molecular weight of the outlet gas feed using at least one outlet gas molecular weight sensor located on one of the at least one outlet conduit and located external to the chamber;
(d) controlling at least one operating parameter of the process as a function of the molecular weight of the inlet gas feed measured in step (b) and the molecular weight of the outlet gas feed measured in step (c); and
(e) performing steps (b) through (d) during at least a portion of the performance of step (a).

2. The method of claim 1, wherein step (e) further comprises repeatedly performing steps (b) through (d) during at least a portion of the performance of step (a).

3. The method of claim 1, wherein step (b) further comprises measuring a molecular weight of the inlet gas feed using the at least one inlet gas molecular weight sensor located on one of the at least one inlet conduit and located external to the chamber.

4. The method of claim 1, wherein step (d) comprises controlling at least one operating parameter of the process as a function of the measured inlet and outlet gas molecular weights, wherein the operating parameter is selected from the group consisting of an ammonia flow rate to the at least one inlet conduit, a nitrogen flowrate to the at least one inlet conduit, and the temperature of the chamber.

5. The method of claim 1, wherein step (a)(ii) further comprises mixing the premix feed and the ammonia feed upstream from the inlet gas molecular weight sensor.

6. The method of claim 5, wherein step (a)(ii) further comprises supplying the inlet gas feed comprising the ammonia feed and the premix feed to the chamber through the at least one inlet conduit, the premix feed consisting of nitrogen.

7. The method of claim 5, wherein step (a)(ii) further comprises supplying a nitrogen gas feed, a hydrogen gas feed, and the ammonia gas feed, mixing the hydrogen gas feed with the nitrogen gas feed to create the premix gas feed and wherein step (b) further comprises measuring a molecular weight of the premix gas feed using the at least one inlet gas molecular weight sensor.

8. The method of claim 1, wherein the at least one outlet conduit includes a primary outlet conduit and a sampling conduit having sampling pump and step (c) further comprises:
i. activating the sample pump to cause a gas sample to be withdrawn from the chamber and into the sampling conduit; and
ii. measuring the molecular weight of the outlet gas feed using the at least one sampling conduit gas molecular weight sensor located in the sampling conduit.

9. An apparatus for nitriding a metal article comprising:
a furnace having a chamber;
a premix conduit in fluid flow communication with a supply of nitrogen gas;
an ammonia conduit in fluid flow communication with a supply of ammonia;
an inlet feed conduit in fluid communication with, and downstream from, the premix conduit and the ammonia conduit;
an inlet molecular weight sensor located external to the chamber and on one selected from the group of the premix conduit and the inlet feed conduit;
at least one exhaust conduit in fluid flow communication with the chamber;
an exhaust molecular weight sensor located external to the chamber and on one of the at least one exhaust conduit;
a controller in electrical communication with the inlet molecular weight sensor and the exhaust molecular weight sensor, the controlled being operationally configured to collect molecular weight data based on electrical signals received from the inlet molecular weight sensor and the exhaust molecular weight sensor;
wherein the controller is operationally configured to control at least one operational parameter of the apparatus as a function of the collected molecular weight data, the at least one operation parameter including a flow rate of ammonia through the ammonia conduit.

10. The apparatus of claim 9 wherein the at least one operational parameter comprises at least one selected from the group consisting of the flow rate of ammonia through the ammonia conduit, a flow rate of nitrogen through the nitrogen premix conduit, and a temperature of the chamber.

11. The apparatus of claim 9, wherein the inlet molecular weight sensor is located on the inlet feed conduit.

12. The apparatus of claim 9, wherein the controller is operationally configured to calculate a nitriding potential of the chamber as a function of the molecular weight data.

13. The apparatus of claim 9, wherein the at least one exhaust conduit in fluid flow communication with the chamber comprises a primary exhaust conduit and a sample conduit, the sample conduit including a sampling pump that is operationally configured to selectively enable fluid flow through the sample conduit, wherein the exhaust molecular weight sensor is located on the sampling conduit.

14. The apparatus of claim 9, wherein the premix conduit is in fluid flow communication with a supply of nitrogen gas and a supply of hydrogen gas.

15. The apparatus of claim 14, wherein the inlet molecular weight sensor is located on the premix conduit.

16. The method of claim 1, wherein step (d) further comprises calculating an ammonia dissociation rate as a function of the molecular weight of the inlet gas feed measured in step (b) and the molecular weight of the outlet gas feed measured in step (c).

17. The method of claim 16, wherein step (d) further comprises calculating a nitriding potential of the furnace.

18. The method of claim 16, wherein the controller is operationally configured to perform a diffusion model to predict the final nitride layer thickness that will be generated on the work piece.

19. The apparatus of claim 9, wherein the at least one of the inlet molecular weight sensor and the exhaust molecular weight sensor is operationally configured to measure at least one of a gas pressure, a gas temperature and a gas density.
